(19) United States
(12) Patent Application Publication
(10) Pub. No.: US 2014/0313623 A1
(43) Pub. Date: Oct. 23, 2014

(54) GROUND AUGMENTATION FOR MACHINES WITH FLOATING GROUNDS

(71) Applicant: Caterpillar Inc., Peoria, IL (US)

(72) Inventor: Brian Joseph Huber, CARPENTERSVILLE, IL (US)

(21) Appl. No.: 14/319,367

(22) Filed: Jun. 30, 2014

(51) Int. Cl. H02H 9/08

(52) U.S. Cl. CPC H02H 9/08
USPC 361/43

(57) ABSTRACT

An electrical equalization system for use with an electric drive train, and at least one critical component within an electric machine, is disclosed. The electric drive train includes a generator with a generator neutral and a motor with a motor neutral. Additionally, the electric machine includes a ground that is subject to an external charge. The electrical equalization system includes a first capacitor positioned between the generator neutral and the ground, and a second capacitor positioned between the motor neutral and the ground. Both the first and second capacitors are structured and arranged to cause a voltage equalization between at least one of the motor and/or the generator and the at least one critical component in response to an external charge event directed to the system.

### TECHNICAL FIELD

The present disclosure relates generally to augmentation of ground faults within electric drive trains of electric machines. More specifically, the present disclosure relates to equalization of floating grounds in machines that are electrically operated.

### BACKGROUND

Electrically operated Large Mining Trucks (LMT) that run under rigorous operational conditions frequently develop vulnerabilities towards a voltage fault over time. Apart from general wear and tear, component degradation, and reduced efficiency, an unaddressed exposure to a voltage fault may result in extended machine downtime. Although it is understood that many voltage faults result from wear of insulation resulting in metal-to-metal contact, other forms of degradation may occur such as moisture entrapment or improper servicing of electrical components and affiliated replacement parts.

In general, it is known to provide a fault grounding strategy to electric systems to protect certain portions of the machine from becoming electrified if an electrical component short circuits and comes in contact with surrounding conductive structures. Principally, a fault grounding method includes a method to channel electric faults, with minimum voltage drop, to the earth. Certain grounding techniques employ floating ground systems that apply neutral lines with considerably high impedance values. When a frame of an electric machine operates with a floating ground, parasitic currents are often generated which run through paths not meant for typical electric connection. For example, in electrical systems having induction motors, insulation systems of these motors may be affected by wear since the portion of the motor that rotates often subjects surrounding parts of the motor to harmonic load and vibration, which over time may cause wear and malfunction to the insulator. The cyclic heating of the motors as well as the substantially significant wear of components that manage high levels of voltage or current may also be subject to cyclic heating and resulting degradation. The electrical systems for these machines are often designed to manage operational electricity through high impedance circuits however lower currents developed outside of these circuits are not managed to the same degree.

U.S. Pat. No. 8,040,139 describes an apparatus for monitoring a direct current system for ground faults. Here, an inherent capacitance exists between the direct current system and a corresponding ground. Also, a series of components including a sensor, switches, and a controller, is configured to monitor and measure a related current flow. This reference may provide means to monitor the direct current system for ground faults, however in complex electrical layouts there may be an increased need to stabilize currents before an insulation wear results in a ground fault.

### SUMMARY

Various aspects of the present disclosure are directed towards an electrical equalization system for use within an electric machine. More particularly, the electrical equalization system equalizes a ground fault between an electric drive train and at least one critical component of the electric machine. The electric drive train includes a generator with a generator neutral and a motor with a motor neutral. Further, the electric machine has a ground and is subject to an external charge. The electrical equalization system includes a first capacitor and a second capacitor. The first capacitor is positioned between the generator neutral and the ground, while the second capacitor is positioned between the motor neutral and the ground. Here, the first and second capacitors are structured and arranged to cause a voltage equalization between at least one of the motor or the generator, and the at least one critical component. Voltage equalization occurs in response to an external charge event directed to the system.

### BRIEF DESCRIPTION OF DRAWINGS

FIG. 1 illustrates a machine with an electric drive system, in accordance with the concepts of the present disclosure; and

FIG. 2 illustrates a schematic of an exemplary electrical equalization system, in accordance with the concepts of the present disclosure.

### DETAILED DESCRIPTION OF DRAWINGS

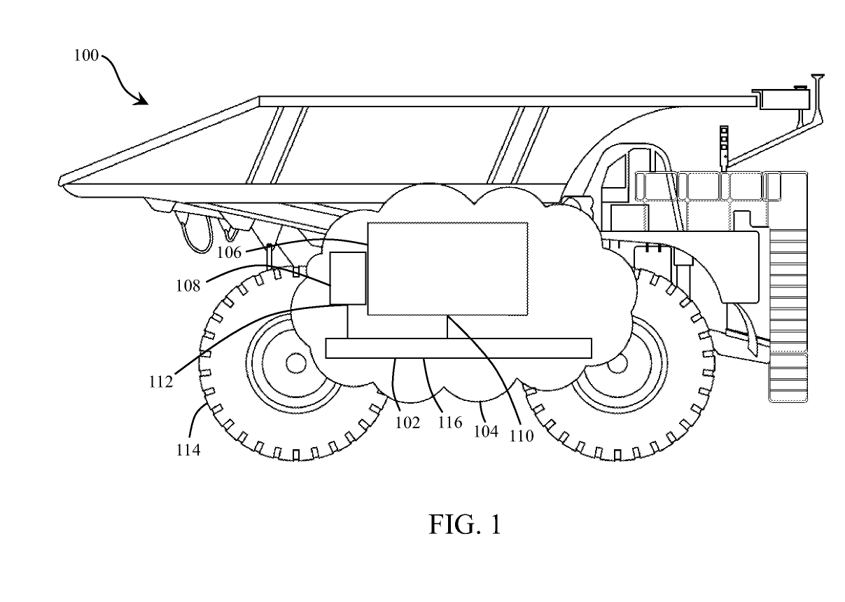

Referring to FIG. 1, there is shown a cutaway schematic of an exemplary machine 100, such as a large mining truck, for example. The machine 100 may be an electrically operated machine with a machine frame 102 and an electric drive train 104. However, the present disclosure contemplates its application to other mobile machines such as track type tractors, excavators and wheel loaders as well as stationary machines such as power generation systems and other electric power generating machines are also envisioned. The electric drive train 104 includes multiple components, such as a generator 106, a motor 108, an inverter (not shown) and a rectifier (not shown). The generator 106 includes a generator neutral 110, the motor 108 includes a motor neutral 112. Although the machine 100, which is described herein, the concepts of the present disclosure may be applicable to any machine that has electrical power generation capability.

The generator 106 may be one of the widely applied generators in the art, which are known to those having ordinary skill, which powers the machine 100. The generator 106 may be mounted near the rear differential (not shown) of the machine 100, although other configurations and positions are contemplated. The generator 106 may be configured to receive electrical energy from a diesel engine (not shown) within the machine 100.

The motor 108 may be a three-phase induction motor and may operably connect to the generator 106 of the machine 100. An interaction of motor 108 with the generator 106 propels the rear wheels 114 of the machine 100. Typically, the motor 108 is mounted inside a rear axle arrangement of the machine 100, to enable ease of service of the motor 108.

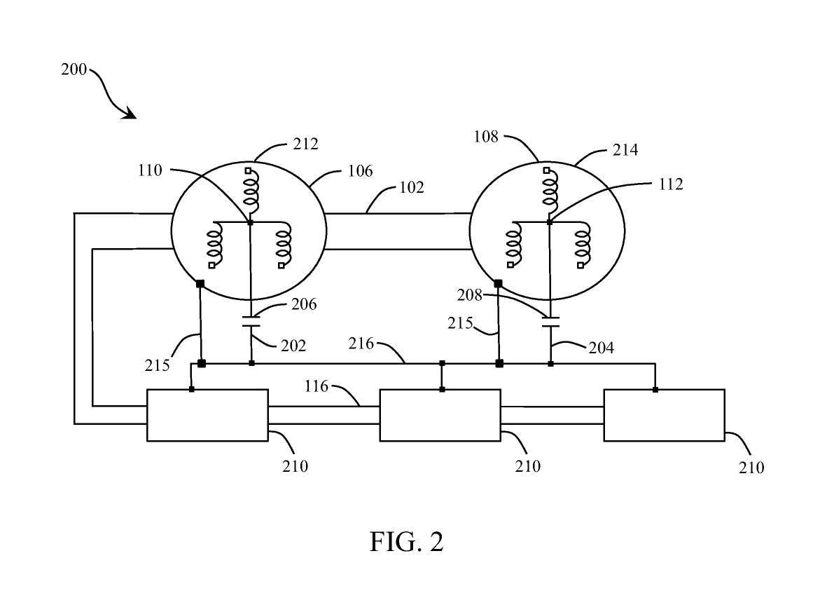

The machine 100 includes an electrical equalization system 200 (FIG. 2) having a ground 116. The ground 116 may be a floating ground supported by the machine frame 102. The ground 116 is connected to the neutral of generator 106, the neutral of motor 108, respectively via capacitors 206 and 208 (see FIG. 2). The ground 116 is also connected to critical components 210 (see FIG. 2).

Referring to FIG. 2, there is shown a schematic of an exemplary electrical equalization system 200 installed within the machine 100. The electrical equalization system 200 may be a floating ground equalization system and includes the generator 106, motor 108, ground 116, a first ground line 202, a second ground line 204, a first capacitor 206, a second capacitor 208, and one or more critical components 210 within the electric drive train 104. The generator 106 includes a generator frame 212 and the motor 108 includes a motor frame 214. Notably, relatively low impedance neutral lines 215 are applied to establish connections between the frames 212, 214 of the motor 108, the generator 106, with the ground 116.

The one or more critical components 210 (hereinafter critical components 210) may be connected to the machine frame 102. Critical components 210 may include, but are not limited to rectifiers, inverters, converters, dynamic braking grids, and blowers. Each of the critical components 210 may include a conductive connection to the electrical equalization system 200. The number of critical components 210 need not be restricted to the depicted embodiment alone. Accordingly, more components may be added to the electrical equalization system 200. Moreover, an independent neutral conductor 216 extends from both the ground lines 202 and 204. The independent neutral conductor 216 is connected to the critical components 210, which ensures that that all critical components 210 are at the same electrical potential.

The generator neutral 110 is connected to the ground 116 through the first ground line 202, while the second ground line 204 connects the motor neutral 112 to the ground 116. Both the ground lines 202 and 204 have relatively low impedance. The first ground line 202 includes the first capacitor 206, which is positioned between the generator neutral 110 and the ground 116. Similarly, the second ground line 204 includes the second capacitor 208, which is positioned between the motor neutral 112 and the ground 116.

The first and second ground lines 202, 204 are respectively connected in a dedicated manner to the neutral 110, 112 of the generator 106 and motor 108, via capacitors 206 and 208. Such a connection is configured to equalize and eventually minimize the subjection of the electrical equalization system 200 to an external charge, and to reduce the effect of stray parasitic fields within the ground 116.

The first and second capacitors 206 and 208 are applied to limit the effects of an electric field, which may continuously vary among the critical components of the machine 100. The capacitors 206 and 208 may be configured to store energy electrostatically in an electric field. Moreover, the capacitors 206 and 208 control an impedance along the first and the second ground lines 202 and 204. In effect, the first and second capacitors 206 and 208 are structured and arranged to cause voltage equalization between the generator 106 and the motor 108, and one or more of the critical components 210, when the electrical equalization system 200 is subject to an external charge event.

In an exemplary embodiment, an on-board engine (not shown) drives the generator 106 and the generator 106 creates electrical energy. Before delivering AC electricity to the motor 108, a rectifier (not shown) converts the AC electricity into direct current (DC) electricity. Subsequently, an inverter converts the DC electricity into a fixed frequency AC supply. The inverter then delivers that fixed frequency AC supply to the motor 108, which uses the received input to drive rear wheels 114 of the machine 100. In one embodiment, wherein the AC electricity being generated as the motor 108 is retarded, the wheel motors act as generators. Power from the motor 108 is fed back through the DC link to contactor and chopper circuits (not shown) and it is then exhausted through a grid. An AC fan (not shown) may be employed to drive air across the grid to dissipate heat and assist with control of the retarding speed. In contrast, during a drive command (as compared to retardation or deceleration command) the generator 106 generates electrical energy in the form of AC electricity. Before delivering the AC electricity to the motor 108, a rectifier (not shown) converts the AC electricity into direct current (DC) electricity. A DC link supplies power to the inverter where Insulated-Gate Bipolar Transistors (IGBT's) convert the DC signal to 3-phase constant frequency AC to drive the traction motors. The inverter then delivers a generally constant frequency AC supply to the motor 108 and, in turn, the motor 108 drives the rear wheels 114 of the machine 100.

Industrial Applicability

In operation, the machine 100 includes the machine frame 102 which supports a floating ground for the operational circuit (not shown). The operational circuit is constructed to power and propel all aspects of the machine 100 as is customary. In contrast, the machine frame 102 connected to the floating ground (ground 116) may also experience rogue electrical currents from external sources and parasitic currents through worn insulation, as has been described. The rogue currents may be driven through unpredictable paths and with greater frequency relative to three phase traction systems such as the typical system with electric drive machines. Machine 100 includes rotating component insulation features that often sustain increased harmonic loading resulting from the floating frame ground (ground 116). These unwanted parasitic currents may cause heating effects and/or may also result in arc discharge, which in turn, may cause significant damage to the power system of the machine 100.

In response to these rogue and parasitic currents, the machine 100 includes an electrical equalization system 200. Electrical equalization system 200, includes the capacitors 206 and 208 which act as buffers or filters and regulate allowance of only part of the equalizing current to pass through, thereby imparting a low impedance path for these rogue currents. In addition to addressing the parasitic currents with lower impedance circuitry, the capacitors 206, 208 allow the higher operational current of the critical components 210 to connect with the capacitors and accordingly carry out their energy storage and discharge functions.

In operation, the capacitors 206 and 208 will provide an AC low impedance return path for currents induced in the machine frame 102 from any stray generated currents. Thus, the electrical equalization system 200 equalizes the distributed machine electrical impedances and results in the reduction of spurious AC faults. Therefore, the established low impedance path reduces rogue or stray parasitic fields and electromagnetic interferences and thereby such electrostatic interference may be discharged and therefore neutralized by the electrical equalization system 200. The low impedance AC path thus formed protects insulation of the machine 100 which would otherwise by vulnerable to degradation by harmonic currents.

Advantageously, a diagnosis of the capacitors 206 and 208 may facilitate measurement of a potential at which the machine 100 operates. Accordingly, provisions may be contemplated to measure a system potential upon the breach of a predetermined value.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. An electrical equalization system for use with an electric drive train and at least one critical component of an electric machine, the electric drive train having a generator with a generator neutral and a motor with a motor neutral, the electric machine including a ground and being subject to an external charge, the system comprising:
a first capacitor positioned between the generator neutral and the ground; and
a second capacitor positioned between the motor neutral and the ground, wherein the first capacitor and the second capacitor being structured and arranged to cause a voltage equalization between at least one of the motor or the generator and the at least one critical component in response to an external charge event directed to the electrical equalization system.
